(19) United States
(12) Patent Application Publication
(10) Pub. No.: US 2026/0233734 A1
(43) Pub. Date: Aug. 13, 2026

(54) METHOD AND SYSTEM FOR DETERMINING DIRECTION OF COLLISION AVOIDANCE WITH FRONT VEHICLE

(71) Applicant: HL Klemove Corp., Incheon (KR)

(72) Inventor: Mingyu KIM, Incheon (KR)

(73) Assignee: HL Klemove Corp., Incheon (KR)

(21) Appl. No.: 19/291,070

(22) Filed: Aug. 5, 2025

(30) Foreign Application Priority Data
Feb. 12, 2025 (KR) 10-2025-0017955

(51) Int. Cl. B60W 30/09; B60W 10/18; B60W 10/20; B60W 30/095; B60W 50/14

(52) U.S. Cl. CPC B60W 30/09; B60W 10/18; B60W 10/20; B60W 30/0956; B60W 50/14; B60W 2420/403; B60W 2420/408; B60W 2520/105; B60W 2540/18; B60W 2552/53; B60W 2554/4041; B60W 2554/801

(57) ABSTRACT

A method for determining a direction of collision avoidance with a front vehicle according to an embodiment of the present disclosure comprises: recognizing a front vehicle of an ego vehicle; determining whether emergency steering control is required based on a collision risk with the front vehicle; when the emergency steering control is determined to be required, determining whether a lateral position of the front vehicle within a driving lane of the ego vehicle satisfies a predetermined first condition; determining whether a relative lateral position between the ego vehicle and the front vehicle satisfies a predetermined second condition; if the first condition is satisfied, or if the first condition is not satisfied but the second condition is satisfied, determining one of a left or right direction as an avoidance direction; and performing steering control of the ego vehicle in the avoidance direction.

### CROSS-REFERENCE TO RELATED APPLICATION

This application claims the benefit of and priority to Korean Patent Application No. 10-2025-0017955 filed on Feb. 12, 2025, the entire disclosures of which are incorporated herein by reference.

### TECHNICAL FIELD

The present disclosure relates to a method and system for determining a direction of collision avoidance with a front vehicle. More specifically, the present disclosure relates to a method and system for determining a direction of collision avoidance with a front vehicle capable of determining an optimal avoidance direction when avoiding a collision with a front vehicle through emergency steering control.

### BACKGROUND

In a vehicle, a Driver Assistance System provides support to the driver while driving for the driver's convenience.

For example, an Autonomous Emergency Steering (AES) system refers to a function that automatically controls the steering wheel to perform steering avoidance when the vehicle detects a risk of a front collision.

Meanwhile, when a risk of collision with a front vehicle is detected, emergency steering control is necessary, and at this time, there is a need to quickly determine in which direction, left or right, the ego vehicle should perform the avoidance maneuver.

However, according to the prior art, there was a problem in that a sufficient logic for determining the avoidance direction in emergency steering control was not established.

Therefore, there is a need for a method and system for determining a front vehicle collision avoidance direction capable of rapidly determining the optimal avoidance direction for the ego vehicle when performing avoidance control according to a front collision risk.

### SUMMARY

The present disclosure is to solve the problems of the prior art described above, and an object of the present disclosure is to provide a method and system for determining a direction of collision avoidance with a front vehicle capable of instantly determining a reasonable avoidance direction by considering the avoidance space, the lateral position of the target (front vehicle), etc., when determining the avoidance direction according to emergency steering avoidance.

Further, an object of the present disclosure is to provide a method and system for determining a direction of collision avoidance with a front vehicle capable of rapidly determining the avoidance direction by additionally considering the type of lane lines and the driver's steering intention if it is difficult to determine the direction based solely on the avoidance space or the target's lateral position during emergency steering control.

However, the technical problems to be achieved by the embodiments of the present disclosure are not limited to the technical problems described above, and other technical problems may exist.

As a technical means for achieving the above technical problem, a method for determining a direction of collision avoidance with a front vehicle according to an embodiment of the present disclosure comprises: recognizing a front vehicle of an ego vehicle; determining whether emergency steering control is required based on a collision risk with the front vehicle; when the emergency steering control is determined to be required, determining whether a lateral position of the front vehicle within a driving lane of the ego vehicle satisfies a predetermined first condition; determining whether a relative lateral position between the ego vehicle and the front vehicle satisfies a predetermined second condition; if the first condition is satisfied, or if the first condition is not satisfied but the second condition is satisfied, determining one of a left or right direction as an avoidance direction; and performing steering control of the ego vehicle in the avoidance direction.

Further, the determining of whether the lateral position satisfies the first condition may comprise: detecting a first lateral distance between a leftmost body of the front vehicle and a left lane line of the driving lane and detecting a second lateral distance between a rightmost body of the front vehicle and a right lane line of the driving lane; calculating a difference between the first lateral distance and the second lateral distance; and determining whether the difference between the first lateral distance and the second lateral distance exceeds a predetermined first threshold value.

Further, the determining of whether the lateral position satisfies the first condition may comprise determining that the first condition is satisfied if the difference between the first lateral distance and the second lateral distance exceeds the predetermined first threshold value.

Further, if the first condition is determined to be satisfied, the determining of the avoidance direction may comprise: comparing the first lateral distance and the second lateral distance; and determining the avoidance direction towards a side with a greater lateral distance.

Further, the determining of whether the relative lateral position satisfies the second condition may comprise: calculating a lateral distance between a centerline of the front vehicle and a centerline of the ego vehicle; and determining whether the lateral distance between the centerlines exceeds a predetermined second threshold value.

Further, the determining of whether the relative lateral position satisfies the second condition may comprise determining that the second condition is satisfied if the lateral distance between the centerlines exceeds the predetermined second threshold value.

Further, if the second condition is determined to be satisfied, the determining of the avoidance direction may comprise: determining the right side as the avoidance direction if the ego vehicle is positioned to the right of the front vehicle; and determining the left side as the avoidance direction if the ego vehicle is positioned to the left of the front vehicle.

Further, the method may further comprise: if neither the first condition nor the second condition is satisfied, determining the avoidance direction towards a side corresponding to a lane line permitted for lane change among the left lane line and the right lane line, wherein a lane line may be determined to be permitted for lane change if a type of the lane line is dashed, and a lane line may be determined not to be permitted for lane change if the type of the lane line is solid.

Further, if neither the first condition nor the second condition is satisfied, and if both the left lane line and the right lane line are permitted for lane change, the determining of the avoidance direction may comprise determining the avoidance direction based on a direction of a steering angular velocity of the ego vehicle.

Further, if neither the first condition nor the second condition is satisfied, and if both the left lane line and the right lane line are not permitted for lane change, the method may further comprise controlling the emergency steering control of the ego vehicle not to operate.

A system for determining a direction of collision avoidance with a front vehicle according to embodiments of the present disclosure comprises: a first sensor configured to detect a front vehicle of an ego vehicle; a second sensor configured to detect body information of the ego vehicle; and a controller comprising at least one processor configured to determine an avoidance direction of the ego vehicle when emergency steering control is required, based on detection results from the first sensor and the second sensor, wherein the controller is configured to: determine whether a lateral position of the front vehicle within a driving lane of the ego vehicle satisfies a predetermined first condition; determine whether a relative lateral position between the ego vehicle and the front vehicle satisfies a predetermined second condition; if the first condition is satisfied, or if the first condition is not satisfied but the second condition is satisfied, determine one of a left side or a right side as the avoidance direction; and perform steering control of the ego vehicle in the avoidance direction.

Further, the controller may be configured to: determine a first lateral distance between a leftmost body of the front vehicle and a left lane line of the driving lane and a second lateral distance between a rightmost body of the front vehicle and a right lane line of the driving lane; determine that the first condition is satisfied if a difference between the first lateral distance and the second lateral distance exceeds a predetermined first threshold value; and determine the avoidance direction towards a side with a greater lateral distance by comparing the first lateral distance and the second lateral distance.

Further, the controller may be configured to: determine that the second condition is satisfied if a lateral distance between a centerline of the front vehicle and a centerline of the ego vehicle exceeds a predetermined second threshold value; and if the second condition is satisfied, determine the right side as the avoidance direction if the ego vehicle is positioned to the right of the front vehicle, and determine the left side as the avoidance direction if the ego vehicle is positioned to the left of the front vehicle.

Further, if neither the first condition nor the second condition is satisfied, the controller may be configured to determine the avoidance direction towards a side corresponding to a lane line permitted for lane change among the left lane line and the right lane line, and wherein the controller may be configured to determine that a lane line is permitted for lane change if a type of the lane line is dashed, and a lane line is not permitted for lane change if the type of the lane line is solid.

Further, if neither the first condition nor the second condition is satisfied, and if both the left lane line and the right lane line are permitted for lane change, the controller may be configured to determine the avoidance direction based on a direction of a steering angular velocity of the ego vehicle.

Further, if neither the first condition nor the second condition is satisfied, and if both the left lane line and the right lane line are not permitted for lane change, the controller may be configured to control the emergency steering control of the ego vehicle not to operate.

Further, the first sensor may comprise at least one of a front camera, a front radar, or a corner radar, and the second sensor may comprise at least one of a speed sensor or an acceleration sensor.

Further, the controller may be connected to: a driving apparatus configured to control longitudinal driving of the ego vehicle; a braking apparatus configured to control braking of the ego vehicle; and a steering apparatus configured to control lateral driving of the ego vehicle, and wherein the controller may be configured to control at least one of the driving apparatus, the braking apparatus, or the steering apparatus to perform avoidance control of the ego vehicle in the determined avoidance direction.

Further, the controller may be connected to a warning apparatus configured to provide a notification to a driver of the ego vehicle, and the controller may be configured to control the warning apparatus to notify the driver of the avoidance direction during the emergency steering control of the ego vehicle.

Meanwhile, in a non-transitory computer-readable recording medium that records a program for determining a direction of collision avoidance with a front vehicle according to an embodiment of the present disclosure, the method comprises: recognizing a front vehicle of an ego vehicle; determining whether emergency steering control is required based on a collision risk with the front vehicle; when the emergency steering control is determined to be required, determining whether a lateral position of the front vehicle within a driving lane of the ego vehicle satisfies a predetermined first condition; determining whether a relative lateral position between the ego vehicle and the front vehicle satisfies a predetermined second condition; if the first condition is satisfied, or if the first condition is not satisfied but the second condition is satisfied, determining one of a left or right direction as an avoidance direction; and performing steering control of the ego vehicle in the avoidance direction.

The above-described means for solving the problem is only exemplary and should not be construed as limiting the present disclosure. In addition to the exemplary embodiments described above, additional embodiments may exist in the drawings and the following detailed description.

According to the problem-solving means of the present disclosure described above, when avoiding a collision with a front vehicle through emergency steering control, it is possible to provide a method and system for determining a direction of collision avoidance with a front vehicle that can effectively determine the avoidance direction by considering the avoidance space and the lateral position of the target.

Further, according to the present disclosure, when avoiding a collision with a front vehicle through emergency steering control, in case that it is difficult to determine the avoidance direction based on the avoidance space and the target's lateral position, it is possible to provide a method and system for determining a direction of collision avoidance with a front vehicle that can effectively determine the avoidance direction based on the type of lane lines or the driver's intention.

However, the effects obtainable from the present disclosure are not limited to the effects described above, and other effects may exist.

### BRIEF DESCRIPTION OF THE DRAWINGS

FIG. 1 is a control flowchart showing a method for determining a direction of collision avoidance with a front vehicle direction according to an embodiment of the present disclosure.

FIG. 2 is a control flowchart showing in more detail the step of determining whether the first condition is satisfied in the method for determining the direction of collision avoidance with the front vehicle according to the embodiment of the present disclosure.

FIG. 3 is a control flowchart showing in more detail the step of determining whether the second condition is satisfied in the method for determining the direction of collision avoidance with the front vehicle according to the embodiment of the present disclosure.

FIG. 4A is a diagram showing a driving scenario satisfying the first condition, and FIG. 4B is a diagram showing a driving scenario satisfying the second condition, in the method for determining the direction of collision avoidance with the front vehicle according to the embodiment of the present disclosure.

FIGS. 5A and 5B are diagrams showing driving scenarios when neither the first condition nor the second condition is satisfied, and the left or right lane line is a lane line permitted for lane change, in the method for determining the direction of collision avoidance with the front vehicle according to the embodiment of the present disclosure.

FIG. 6 is a control configuration diagram schematically showing a configuration of a system for determining a direction of collision avoidance with a front vehicle according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where

### They Are “indirectly Connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and system for determining a direction of collision avoidance with a front vehicle direction that can effectively determine the avoidance direction during steering avoidance control of a vehicle.

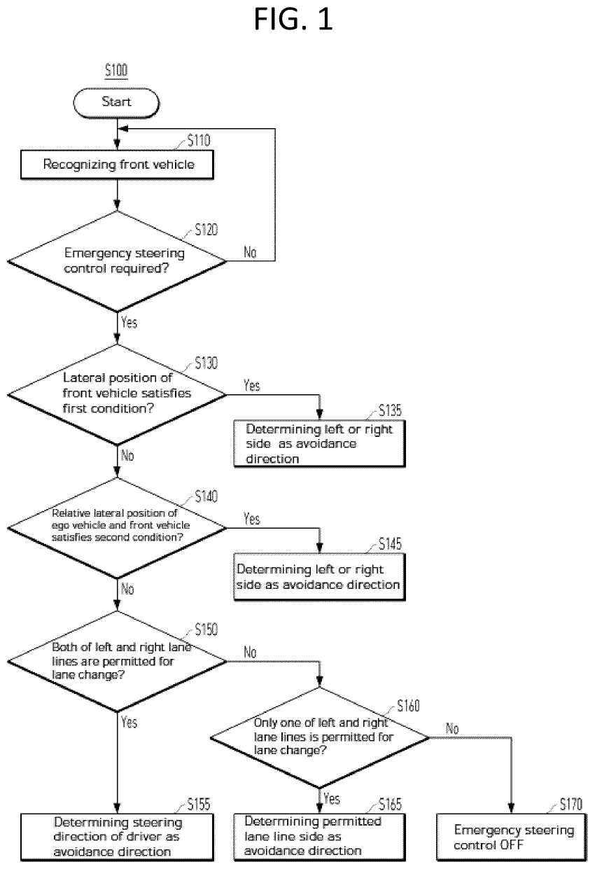

FIG. 1 is a control flowchart showing a method for determining a direction of collision avoidance with a front vehicle direction according to an embodiment of the present disclosure.

Referring to FIG. 1, the method for determining a direction of collision avoidance with a front vehicle S100 according to an embodiment of the present disclosure may comprise recognizing a front vehicle of the ego vehicle S110. For example, the front vehicle may be recognized by a front camera and/or a front radar installed in the ego vehicle.

Subsequently, determining whether emergency steering control is required for the front vehicle S120 may be performed. For example, based on the collision risk with the front vehicle, it may be determined whether the ego vehicle has a collision risk with the front vehicle, and if there is a collision risk, it may be determined that emergency steering control is required. Meanwhile, the collision risk may be determined, for example, based on the TTC (Time To Collision) with the front vehicle.

For example, if the TTC between the ego vehicle and the front vehicle is less than a predetermined threshold value, it may be determined that there is a collision risk with the front vehicle, and it may be determined that emergency steering control of the ego vehicle is required.

If emergency steering control for the front vehicle is not required (‘No’ in S120), the process may return to the front vehicle recognition step S110. If emergency steering control for the front vehicle is required (‘Yes’ in S120), a step of determining whether the lateral position of the front vehicle within the driving lane of the ego vehicle satisfies a predetermined first condition S130 may be performed.

If the lateral position of the front vehicle satisfies the predetermined condition (first condition) in the first condition satisfaction determination step S130 (‘Yes’ in S130), the avoidance direction may be determined as the left or right side (S135).

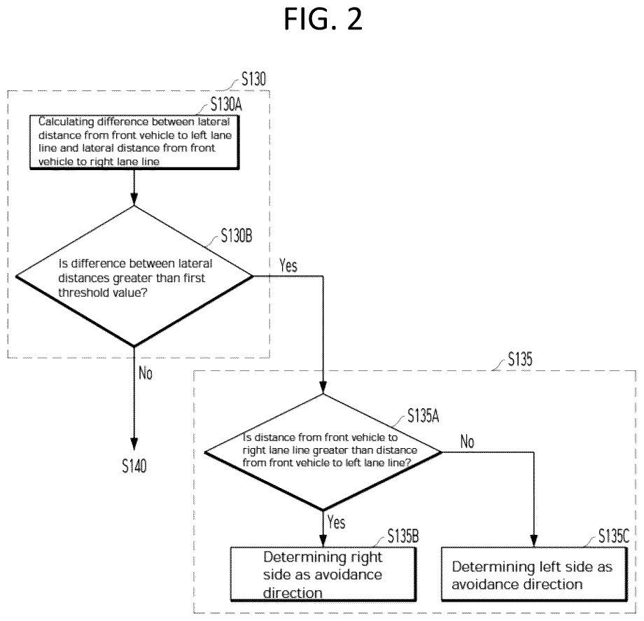

Hereinafter, the first condition satisfaction determination step S130 will be described in more detail with reference to FIG. 2. FIG. 2 is a control flowchart showing in more detail the step of determining whether the first condition is satisfied in the method for determining the direction of collision avoidance with the front vehicle according to the embodiment of the present disclosure.

Referring to FIG. 2, the first condition satisfaction determination step S130 may comprise a step of calculating the difference between the lateral distance from the front vehicle to the left lane line and the right lane line S130A, and a step of determining whether an absolute value of the difference in lateral distances from the front vehicle to the left and right lane lines exceeds a predetermined first threshold value S130B.

Here, the lateral distance from the front vehicle to the left lane line (a first lateral distance) may refer to the shortest distance between the front vehicle and the left lane line (distance between the leftmost body of the front vehicle and the left lane line), and the lateral distance from the front vehicle to the right lane line (a second lateral distance) may refer to the shortest distance between the front vehicle and the right lane line (distance between the rightmost body of the front vehicle and the right lane line). The first lateral distance and the second lateral distance may be detected by a sensor(sensors) mounted at the ego vehicle.

Meanwhile, if the difference in lateral distances (an absolute value of the difference between the first lateral distance and the second lateral distance) exceeds the first threshold value in step S130B (‘Yes’ in S130B), it may be determined whether the distance from the front vehicle to the right lane line (the second lateral distance) is greater than the distance from the front vehicle to the left lane line (the first lateral distance) (S135A). If the distance from the front vehicle to the right lane line (the second lateral distance) is greater (‘Yes’ in S135A), meaning the right avoidance space is larger than the left avoidance space by a certain amount or more, the right side may be determined as the avoidance direction (S135B).

Conversely, if the distance from the front vehicle to the left lane line (the first lateral distance) is greater (‘No’ in S135), meaning the left avoidance space is larger than the right avoidance space by a certain amount or more, the left side may be determined as the avoidance direction (S135C).

Meanwhile, the first threshold value here may be, for example, approximately 10 cm, but the present disclosure is not limited thereto, and the first threshold value may be a settable value.

Further, after the avoidance direction is determined as described above, the ego vehicle may be controlled to perform avoidance steering for the front vehicle, e.g., by performing automatic emergency steering control according to a driver assistance system.

According to the embodiment of the present disclosure described above, if the difference in lateral distances from the front vehicle to the left/right lane lines exceeds the first threshold value, the avoidance direction is determined towards the direction where a larger space is formed, thereby effectively avoiding collision with the front vehicle and also effectively suppressing the possibility of collision with vehicles in adjacent lanes.

Meanwhile, if the absolute value of the difference in lateral distances from the front vehicle to the left/right lane lines does not exceed the first threshold value (‘No’ in S130), step S140 may proceed.

Referring again to FIG. 1, if the first condition regarding the lateral position of the front vehicle is not satisfied (‘No’ in S130), determining whether the relative lateral position between the ego vehicle and the front vehicle satisfies a predetermined second condition S140 may be performed.

If the relative lateral position between the ego vehicle and the front vehicle satisfies the predetermined condition (second condition) (‘Yes’ in S140), the avoidance direction may be determined as the left or right side (S145).

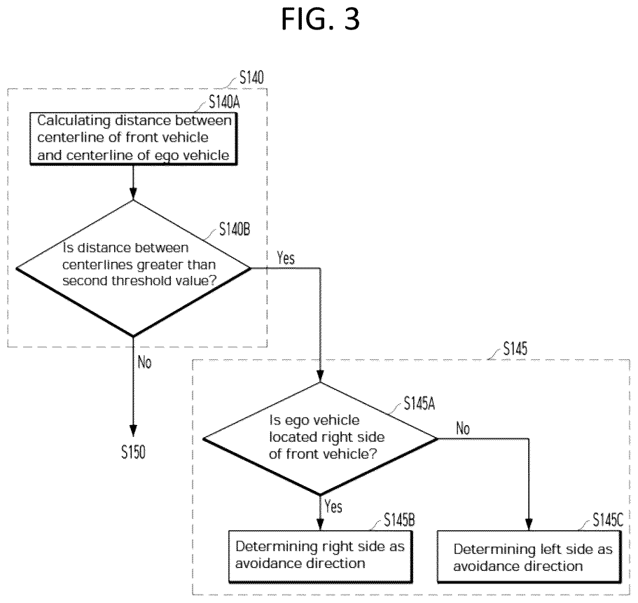

Hereinafter, the second condition satisfaction determination step S140 will be described in more detail with reference to FIG. 3. FIG. 3 is a control flowchart showing in more detail the step of determining whether the second condition is satisfied in the method for determining a direction of collision avoidance with a front vehicle according to the embodiment of the present disclosure.

Referring to FIG. 3, the second condition satisfaction determination step S140 may comprise a step of calculating the lateral distance between the centerline of the front vehicle and the centerline of the ego vehicle S140A, and a step of determining whether the lateral distance between the centerline of the front vehicle and the centerline of the ego vehicle exceeds a predetermined second threshold value S140B.

Here, by calculating the lateral distance between the centerline of the front vehicle and the centerline of the ego vehicle, the relative lateral position between the front vehicle and the ego vehicle may be determined. That is, the second condition satisfaction determination step may determine whether the ego vehicle is positioned to the right or left by a certain amount relative to the front vehicle laterally.

Meanwhile, if the lateral distance between the centerlines exceeds the second threshold value in step S140B (‘Yes’ in S140B), it may be determined whether the ego vehicle is positioned to the right of the front vehicle (S145A). If positioned to the right (‘Yes’ in S145A), the right side may be determined as the avoidance direction (S145B). Meanwhile, if the ego vehicle is positioned to the left of the front vehicle (‘No’ in S145A), the left side may be determined as the avoidance direction (S145C).

Meanwhile, the second threshold value here may be, for example, approximately 10 cm, but the present disclosure is not limited thereto, and the second threshold value may be a settable value.

As described above, if the lateral distance between the front vehicle and the ego vehicle exceeds the second threshold value, the avoidance direction is determined towards the direction of the lane line closer to the ego vehicle, thereby effectively preventing collision with the front vehicle when performing emergency steering control.

Meanwhile, if neither the first condition nor the second condition is satisfied (‘No’ in S140), it may correspond to a case where the distance (space) between the front vehicle and the left/right lane lines is insufficient for steering avoidance, and thus, where determining the avoidance direction based solely on the lateral position of the front vehicle or the relative lateral position between the ego vehicle and the front vehicle is difficult.

Referring again to FIG. 1, if neither the first condition nor the second condition is satisfied (‘No’ in S140), it may be determined whether both the left and right lane lines are lane lines permitted for lane change (S150). If both lane lines are permitted for lane change (‘Yes’ in S150), the avoidance direction may be determined based on the steering angular velocity direction of the ego vehicle (i.e., the driver's steering direction) (S155).

Here, determining the avoidance direction based on the steering angular velocity direction of the ego vehicle is intended to determine the direction for emergency steering according to the driver's intention in situations where it is difficult to determine the emergency steering direction based only on the first and second conditions.

Meanwhile, if only one of the left or right lane lines is permitted for lane change (‘Yes’ in S160), the avoidance direction may be determined towards the side of the lane line permitted for lane change (S165).

Here, a lane line permitted for lane change may refer to a lane line that allows lane change according to traffic regulations. For example, if the lane line type is dashed, it may be determined as a lane line permitted for lane change, and if the lane line type is solid, it may be determined as a lane line not permitted for lane change. However, it is not limited thereto, and lane lines permitted for lane change and those not permitted for lane change based on traffic regulations may exist in other forms.

Further, if both the left and right lane lines are not permitted for lane change (‘No’ in S160), emergency steering control may be controlled to the OFF state, thereby controlling the emergency steering control of the ego vehicle not to operate (S170).

According to the method for determining the direction of collision avoidance with the front vehicle according to the embodiment described above, in situations requiring emergency steering control of the ego vehicle, it is possible to determine the optimal avoidance direction based on the positional relationship with the front vehicle.

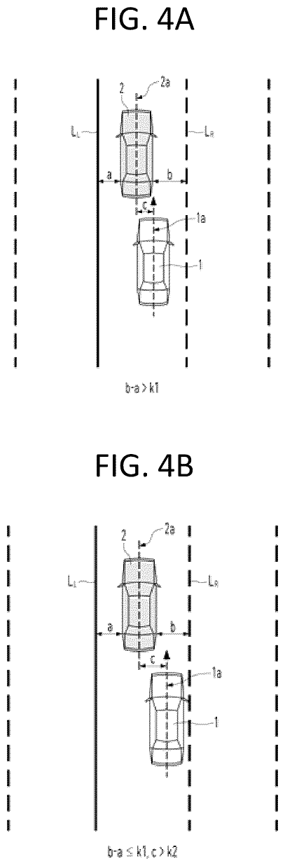

FIG. 4A is a diagram showing a driving scenario satisfying the first condition, and FIG. 4B is a diagram showing a driving scenario satisfying the second condition, in the method for determining the direction of collision avoidance with the front vehicle according to the embodiment of the present disclosure.

Referring to FIG. 4A, after recognizing the front vehicle 2, if it is determined that emergency steering control for the front vehicle 2 is required, it may be determined whether the lateral position of the front vehicle 2 within the driving lane of the ego vehicle 1 satisfies the predetermined first condition.

Satisfaction of the first condition may be determined through whether the difference (b−a) between the lateral distance from the front vehicle 2 to the right lane line L_{R} and the lateral distance from the front vehicle 2 to the left lane line L_{L} exceeds a predetermined first threshold value k1. In FIG. 4A, as the difference (b−a) exceeds the first threshold value k1 (b−a>k1), the avoidance direction may be determined towards the direction with the larger distance between the front vehicle and a lane line (right side in FIG. 4A).

Referring to FIG. 4B, if the difference (b−a) between the lateral distance from the front vehicle 2 to the right lane line L_{R} and the lateral distance from the front vehicle 2 to the left lane line L_{L} is less than or equal to the predetermined first threshold value k1 (b−a≤k1), the relative lateral position between the ego vehicle 1 and the front vehicle 2 may be determined.

The relative lateral position between the ego vehicle 1 and the front vehicle 2 may be determined through the lateral distance c between the centerline 1a of the ego vehicle 1 and the centerline 2a of the front vehicle 2. As shown in FIG. 4B, if the lateral distance c between the centerline 1a of the ego vehicle 1 and the centerline 2a of the front vehicle 2 exceeds a predetermined second threshold value k2 (c>k2), the avoidance direction may be determined towards the lane line side closer to the ego vehicle 1 (right lane line side in FIG. 4B).

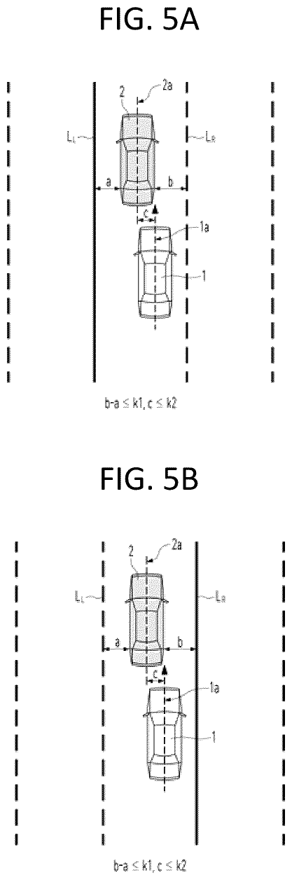

FIGS. 5A and 5B are diagrams showing driving scenarios when neither the first condition nor the second condition is satisfied, and the left or right lane line is a lane line permitted for lane change, in the method for determining the direction of collision avoidance with the front vehicle according to the embodiment of the present disclosure.

Referring to FIGS. 5A and 5B, if the difference (b−a) between the lateral distances is less than or equal to the first threshold value k1 (b−a≤k1), and the lateral distance c between the centerlines is less than or equal to the second threshold value k2 (c≤k2), it may be determined that neither the first nor the second condition is satisfied.

In this case, the types of the lane lines on both sides of the driving lane (left lane line L_{L} and right lane line L_{R}) may be determined to decide the avoidance direction.

For example, as shown in FIG. 5A, if the right lane line L_{R} is a dashed line, meaning the right lane line is permitted for lane change, the avoidance direction may be determined towards the right lane line side (right direction).

Meanwhile, as shown in FIG. 5B, if the left lane line L_{L} is a dashed line, meaning the left lane line is permitted for lane change, the avoidance direction may be determined towards the left lane line side (left direction).

As described above, according to the method for determining a direction of collision avoidance with a front vehicle according to the embodiment, the avoidance direction for emergency steering control can be reasonably determined based on the positional relationship between the front vehicle and the ego vehicle within the lane, and the type of lane lines.

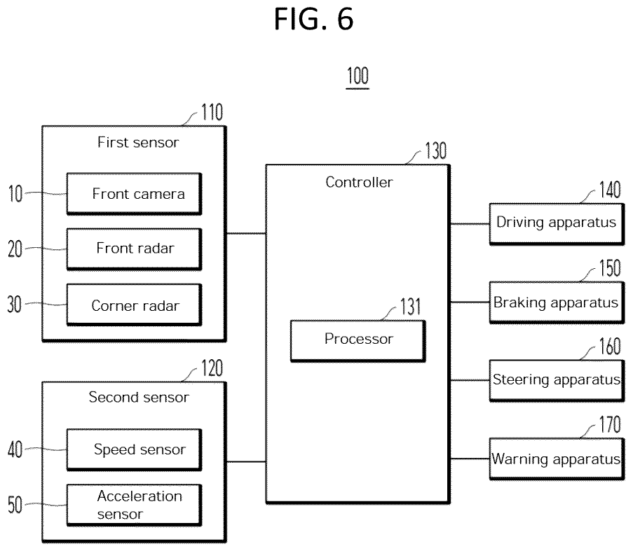

FIG. 6 is a control configuration diagram schematically showing a configuration of a system for determining a direction of collision avoidance with a front vehicle according to embodiments of the present disclosure.

Referring to FIG. 6, the system for determining a direction of collision avoidance with a front vehicle 100 according to embodiments comprises: a first sensor 110 configured to detect a front vehicle of an ego vehicle; a second sensor 120 configured to detect body information of the ego vehicle; and a controller 130 comprising at least one processor 131 configured to determine an avoidance direction of the ego vehicle when emergency steering control is required, based on the detection results from the first sensor 110 and the second sensor 120.

The controller 130 may determine whether the lateral position of the front vehicle within the driving lane of the ego vehicle satisfies a predetermined first condition, and determine whether the relative lateral position between the ego vehicle and the front vehicle satisfies a predetermined second condition. If the first condition is satisfied, or if the first condition is not satisfied but the second condition is satisfied, the avoidance direction may be determined towards one of the left or right sides, and steering control of the ego vehicle may be performed in the avoidance direction.

The first sensor 110 may include at least one of a front camera 10, a front radar 20, or a corner radar 30. However, the configuration of the first sensor 110 is not limited thereto, and may include other types of sensors for detecting the front vehicle and the surroundings of the ego vehicle, such as corner radars, ultrasonic sensors, lidar sensors, etc.

The second sensor 120 may include at least one of a speed sensor 40 or an acceleration sensor 50. However, the configuration of the second sensor 120 is not limited thereto, and may include other types of sensors for detecting the body information of the ego vehicle, such as a steering angle sensor, a steering torque sensor, etc., if applicable.

The controller 130 may determine that the first condition is satisfied if the difference in lateral distances from the front vehicle to the left/right lane lines exceeds a predetermined first threshold value, compare the distance from the front vehicle to the right lane line with the distance from the front vehicle to the left lane line, and determine the avoidance direction towards the side with the greater distance.

Further, the controller 130 may determine that the second condition is satisfied if the lateral distance between the centerline of the front vehicle and the centerline of the ego vehicle exceeds a predetermined second threshold value. If the ego vehicle is positioned to the right of the front vehicle, the right side may be determined as the avoidance direction, and if the ego vehicle is positioned to the left of the front vehicle, the left side may be determined as the avoidance direction.

Further, if neither the first nor the second condition is satisfied, the controller 130 may determine the avoidance direction towards the side of the lane line permitted for lane change among the left and right lane lines. The controller 130 may determine that a lane line is permitted for lane change if its type is dashed, and determine that a lane line is not permitted for lane change if its type is solid.

Further, if neither the first nor the second condition is satisfied, and both lane lines are permitted for lane change, the controller 130 may determine the avoidance direction based on the steering angular velocity direction of the ego vehicle.

Further, if neither the first nor the second condition is satisfied, and both lane lines are not permitted for lane change, the controller 130 may control the emergency steering control of the ego vehicle not to operate.

Further, the controller 130 may be connected to a driving apparatus 140 configured to control longitudinal driving of the ego vehicle, a braking apparatus 150 configured to control braking of the ego vehicle, and a steering apparatus 160 configured to control lateral driving of the ego vehicle.

Accordingly, the controller 130 may control at least one of the driving apparatus 140, the braking apparatus 150, or the steering apparatus 160 to perform the avoidance maneuver of the ego vehicle in the determined avoidance direction.

Further, the controller 130 may be connected to a warning apparatus 170 configured to provide notification to the driver of the ego vehicle. Accordingly, the controller 130 may control the warning apparatus 170 to notify the driver of the avoidance direction during emergency steering control of the ego vehicle.

This warning apparatus 170 may include at least one of a visual alarm device, an audible alarm device, or a haptic alarm device. Accordingly, through visual, audible, and/or haptic alarms, the driver can be alerted to the avoidance direction according to the emergency steering control, thereby assisting the driver in quickly recognizing the vehicle's driving direction.

Regarding the method for determining a direction of collision avoidance with a front vehicle according to the embodiment of the present disclosure performed by the controller 130, since it has been described in detail previously, a detailed description thereof will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the embodiments of the present disclosure as described above, since the avoidance direction can be automatically determined based on the position of the front vehicle within the driving lane or the relative lateral position between the front vehicle and the ego vehicle, it is possible to provide a method and system for determining a direction of collision avoidance with a front vehicle that can rapidly determine the optimal avoidance direction and perform steering control in situations requiring urgent avoidance.

Furthermore, according to the method and system for determining a direction of collision avoidance with a front vehicle according to the embodiments, if it is difficult to determine the avoidance direction based solely on the position of the front vehicle within the lane or the relative lateral position between the front vehicle and the ego vehicle, it is possible to perform steering avoidance according to the driver's steering intention, thereby enhancing the driver's driving convenience.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

1: Ego vehicle
1a: Centerline of ego vehicle
2: Front vehicle
2a: Centerline of front vehicle
10: Front camera
20: Front radar
30: Corner radar
40: Speed sensor
50: Acceleration sensor
100: System for determining direction of collision avoidance with front vehicle
110: First sensor
120: Second sensor
130: Controller
131: Processor
140: Driving apparatus
150: Braking apparatus
160: Steering apparatus
170: Warning apparatus

1. A method for determining a direction of collision avoidance with a front vehicle, comprising:
recognizing a front vehicle of an ego vehicle;
determining whether emergency steering control is required based on a collision risk with the front vehicle;
when the emergency steering control is determined to be required, determining whether a lateral position of the front vehicle within a driving lane of the ego vehicle satisfies a predetermined first condition;
determining whether a relative lateral position between the ego vehicle and the front vehicle satisfies a predetermined second condition;
if the first condition is satisfied, or if the first condition is not satisfied but the second condition is satisfied, determining one of a left or right direction as an avoidance direction; and
performing steering control of the ego vehicle in the avoidance direction.

2. The method of claim 1, wherein the determining of whether the lateral position satisfies the first condition comprises:
detecting a first lateral distance between a leftmost body of the front vehicle and a left lane line of the driving lane and detecting a second lateral distance between a rightmost body of the front vehicle and a right lane line of the driving lane;
calculating an absolute value of a difference between the first lateral distance and the second lateral distance; and
determining whether the absolute value of the difference between the first lateral distance and the second lateral distance exceeds a predetermined first threshold value.

3. The method of claim 2, wherein the determining of whether the lateral position satisfies the first condition comprises determining that the first condition is satisfied if the absolute value of the difference between the first lateral distance and the second lateral distance exceeds the predetermined first threshold value.

4. The method of claim 3, wherein if the first condition is determined to be satisfied, the determining of the avoidance direction comprises:
comparing the first lateral distance and the second lateral distance; and
determining the avoidance direction towards a side with a greater lateral distance.

5. The method of claim 4, wherein the determining of whether the relative lateral position satisfies the second condition comprises:
calculating a lateral distance between a centerline of the front vehicle and a centerline of the ego vehicle; and
determining whether the lateral distance between the centerlines exceeds a predetermined second threshold value.

6. The method of claim 5, wherein the determining of whether the relative lateral position satisfies the second condition comprises determining that the second condition is satisfied if the lateral distance between the centerlines exceeds the predetermined second threshold value.

7. The method of claim 6, wherein if the second condition is determined to be satisfied, the determining of the avoidance direction comprises:
determining the right side as the avoidance direction if the ego vehicle is positioned to the right of the front vehicle; and
determining the left side as the avoidance direction if the ego vehicle is positioned to the left of the front vehicle.

8. The method of claim 1, further comprising:
if neither the first condition nor the second condition is satisfied, determining the avoidance direction towards a side corresponding to a lane line permitted for lane change among the left lane line and the right lane line,
wherein a lane line is determined to be permitted for lane change if a type of the lane line is dashed, and a lane line is determined not to be permitted for lane change if the type of the lane line is solid.

9. The method of claim 8, wherein if neither the first condition nor the second condition is satisfied, and if both the left lane line and the right lane line are permitted for lane change, the determining of the avoidance direction comprises determining the avoidance direction based on a direction of a steering angular velocity of the ego vehicle.

10. The method of claim 9, wherein if neither the first condition nor the second condition is satisfied, and if both the left lane line and the right lane line are not permitted for lane change, the method further comprises controlling the emergency steering control of the ego vehicle not to operate.

11. A system for determining a direction of collision avoidance with a front vehicle, comprising:
a first sensor configured to detect a front vehicle of an ego vehicle;
a second sensor configured to detect body information of the ego vehicle; and
a controller comprising at least one processor configured to determine an avoidance direction of the ego vehicle when emergency steering control is required, based on detection results from the first sensor and the second sensor,
wherein the controller is configured to:
determine whether a lateral position of the front vehicle within a driving lane of the ego vehicle satisfies a predetermined first condition;
determine whether a relative lateral position between the ego vehicle and the front vehicle satisfies a predetermined second condition;
if the first condition is satisfied, or if the first condition is not satisfied but the second condition is satisfied, determine one of a left side or a right side as the avoidance direction; and
perform steering control of the ego vehicle in the avoidance direction.

12. The system of claim 11, wherein the controller is configured to:
determine a first lateral distance between a leftmost body of the front vehicle and a left lane line of the driving lane and a second lateral distance between a rightmost body of the front vehicle and a right lane line of the driving lane;
determine that the first condition is satisfied if an absolute value of a difference between the first lateral distance and the second lateral distance exceeds a predetermined first threshold value; and
determine the avoidance direction towards a side with a greater lateral distance by comparing the first lateral distance and the second lateral distance.

13. The system of claim 12, wherein the controller is configured to:
determine that the second condition is satisfied if a lateral distance between a centerline of the front vehicle and a centerline of the ego vehicle exceeds a predetermined second threshold value; and
if the second condition is satisfied, determine the right side as the avoidance direction if the ego vehicle is positioned to the right of the front vehicle, and determine the left side as the avoidance direction if the ego vehicle is positioned to the left of the front vehicle.

14. The system of claim 11, wherein if neither the first condition nor the second condition is satisfied, the controller is configured to determine the avoidance direction towards a side corresponding to a lane line permitted for lane change among the left lane line and the right lane line, and
wherein the controller is configured to determine that a lane line is permitted for lane change if a type of the lane line is dashed, and a lane line is not permitted for lane change if the type of the lane line is solid.

15. The system of claim 14, wherein if neither the first condition nor the second condition is satisfied, and if both the left lane line and the right lane line are permitted for lane change, the controller is configured to determine the avoidance direction based on a direction of a steering angular velocity of the ego vehicle.

16. The system of claim 15, wherein if neither the first condition nor the second condition is satisfied, and if both the left lane line and the right lane line are not permitted for lane change, the controller is configured to control the emergency steering control of the ego vehicle not to operate.

17. The system of claim 16, wherein the first sensor comprises at least one of a front camera, a front radar, or a corner radar, and the second sensor comprises at least one of a speed sensor or an acceleration sensor.

18. The system of claim 11, wherein the controller is connected to: a driving apparatus configured to control longitudinal driving of the ego vehicle; a braking apparatus configured to control braking of the ego vehicle; and a steering apparatus configured to control lateral driving of the ego vehicle, and
wherein the controller is configured to control at least one of the driving apparatus, the braking apparatus, or the steering apparatus to perform avoidance control of the ego vehicle in the determined avoidance direction.

19. The system of claim 18, wherein the controller is connected to a warning apparatus configured to provide a notification to a driver of the ego vehicle, and the controller is configured to control the warning apparatus to notify the driver of the avoidance direction during the emergency steering control of the ego vehicle.

20. A non-transitory computer-readable recording medium that records a program for executing a method for determining a direction of collision avoidance with a front vehicle on a computer, the method comprising:
recognizing a front vehicle of an ego vehicle;
determining whether emergency steering control is required based on a collision risk with the front vehicle;
when the emergency steering control is determined to be required, determining whether a lateral position of the front vehicle within a driving lane of the ego vehicle satisfies a predetermined first condition;
determining whether a relative lateral position between the ego vehicle and the front vehicle satisfies a predetermined second condition;
if the first condition is satisfied, or if the first condition is not satisfied but the second condition is satisfied, determining one of a left or right direction as an avoidance direction; and
performing steering control of the ego vehicle in the avoidance direction.
